(19) United States
(12) Patent Application Publication
(10) Pub. No.: US 2006/0268896 A1
(43) Pub. Date: Nov. 30, 2006

(54) System and method for services functionality

(76) Inventors: Sakari Kotola, Kauniainen (FI); Petri Vesikivi, Espoo (FI); Teppo Savinen, Vihti (FI); Ari Koli, Helsinki (FI)

Correspondence Address: MORGAN & FINNEGAN, L.L.P., 3 World Financial Center, New York, NY, 10281-2101, US

(21) Appl. No.: 11/142,766

(22) Filed: May 31, 2005

(51) Int. Cl. H04L 12/56

(52) U.S. Cl. 370/400

(57) ABSTRACT

Systems and methods applicable, for instance, in services functionality. For example, a user, company, and/or group wishing to employ a node and/or other computer in promoting a service might provide information to a remote store and/or server. As another example, a user seeking services might employ her node and/or other computer to find nodes and/or other computers promoting services. As yet another example, the node and/or other computer of the user seeking services might communicate with the remote store and/or server, and/or the user might be provided access to one or more services being promoted by nodes and/or other computers. As further examples, data tags might be employed in promoting services, a user, company, and/or group might be able to promote a service on behalf of another, statistics might be maintained, and/or compensation might be provided for services promotion.

### FIELD OF INVENTION

This invention relates to systems and methods for services functionality.

### BACKGROUND INFORMATION

In recent times, there has been an increase in the use of services. For example, many users have come to prefer services such as, for instance, webpages, audio, and/or video to other sources of information, entertainment, data, and/or the like.

Accordingly, there may be interest in technologies applicable, for instance, in services functionality.

### SUMMARY OF THE INVENTION

According to embodiments of the present invention there are provided systems and methods applicable, for instance, in services functionality.

For example, in various embodiments a user, company, and/or group wishing to employ a node and/or other computer in promoting a service might provide information to a remote store and/or server. In various embodiments, a user seeking services might employ her node and/or other computer to find nodes and/or other computers promoting services.

The node and/or other computer of the user seeking services might, in various embodiments, communicate with the remote store and/or server. Moreover, the user might, in various embodiments, be provided access to one or more services being promoted by nodes and/or other computers.

Additionally, in various embodiments data tags might be employed in promoting services, a user, company, and/or group might be able to promote a service on behalf of another, statistics might be maintained, and/or compensation might be provided for services promotion.

### BRIEF DESCRIPTION OF THE DRAWINGS

FIG. 1 shows exemplary steps involved in service promotion setup operations according to various embodiments of the present invention.

FIG. 2. shows exemplary steps involved in service seeking operations according to various embodiments of the present invention.

FIG. 3 shows further exemplary steps involved in service seeking operations according to various embodiments of the present invention.

FIG. 4 shows exemplary steps involved in further promotion operations according to various embodiments of the present invention.

FIG. 5 shows an exemplary computer.

FIG. 6 shows a further exemplary computer.

### DETAILED DESCRIPTION OF THE INVENTION

General Operation

According to embodiments of the present invention there are provided systems and methods applicable, for instance, in services functionality.

For example, in various embodiments a user, company, and/or group wishing to promote a service might, for instance, provide to a remote store and/or server information corresponding to a node and/or other computer to be employed in promoting the service and/or information employable in accessing the service. The user, company, and/or group wishing to promote the service might, in various embodiments, act to make the node and/or other computer to be employed in promoting the service able to be found by nodes and/or other computers employed in seeking services.

A user seeking services might, in various embodiments, employ her node and/or other computer to find nodes and/or other computers promoting services. In the case where one or more such nodes and/or other computers promoting services are found, one or more software modules running remote from and/or at the node and/or other computer of the user seeking services might, in various embodiments, provide for selection by the node and/or other computer's user one or more of the found nodes and/or other computers.

In various embodiments, with the user selecting one of the found nodes and/or other computers, one or more software modules running remote from and/or at the user's node and/or other computer might, by communicating with the remote store and/or server, provide the user access to the service being promoted by the selected node and/or other computer.

Moreover, in various embodiments, data tags might be employed in promoting services, a user, company, and/or group might be able to promote a service on behalf of another user, company, and/or group, statistics might be maintained, and/or compensation might be provided for services promotion.

Various aspects of the present invention will now be discussed in greater detail.

Service Promotion Setup Operations

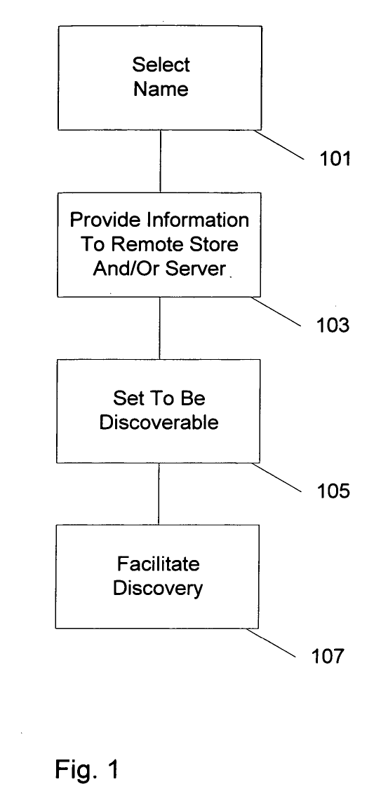

With respect to FIG. 1 it is noted that, according to various embodiments of the present invention, a user, company, and/or group wishing to employ a node and/or other computer (e.g., a Mobile Information Device Profile (MIDP) 2.0 compliant and/or Java Specification Request (JSR) 82 compliant wireless node) in promoting a service might, for example, select a custom identifier for the node and/or other computer (step 101). Such a custom identifier might, for example, be a name (e.g., a Bluetooth friendly name). Such a custom identifier might, for instance, be one made available to one or more software modules running remote from and/or at a node and/or other computer performing device discovery and/or service discovery.

Such device discovery and/or service discovery might, in various embodiments, involve the use of proximity connection such as, for instance, Bluetooth, wireless local area network (e.g., WiFi (Wireless Fidelity)), Ultra Wide Band (UWB), and/or IrDA (Infrared Data Association). Such WiFi might, for instance, be IEEE 802.11b and/or IEEE 802.11g. It is noted that, in various embodiments, other than proximity connection might be employed (e.g., wired networking and/or cellular networking might be employed). Such cellular networking might, for instance, involve Universal Mobile Telecommunications Service (UMTS), and/or General Packet Radio Service (GPRS). It is noted that, in various embodiments, Internet connection might be employed.

Accordingly, for example, such a custom identifier might be made available to one or more software modules running remote from and/or at a node and/or other computer employing Bluetooth Device Discovery, Bluetooth Service Discovery, Domain Name Service—Service Discovery (DNS-SD), and/or Simple Service Discovery Protocol (SSDP).

The custom identifier for the node and/or other computer to be employed in promoting the service might be chosen in a number of ways. For instance, the custom identifier and/or a component thereof might be chosen so as to provide some description and/or indication of the service being promoted, and/or of the user, company, and/or group promoting the service. To illustrate by way of example, the custom identifier or a component thereof might be set to the name of the user, company and/or group (e.g., “Yummy Beverage Corporation”), a description of the service being promoted (e.g., “Hot New Artist Videos”), and/or both (e.g., “Yummy Beverage Presents Hot New Artist Videos”).

It is noted that, in various embodiments the custom identifier might be chosen so as to have a component indicating that the node and/or other computer is being employed in promoting a service. Such a component might, for example, be employable by one or more software modules running remote from and/or at nodes and/or other computers acting in finding nodes and/or other computers in determining that a found node and/or other computer was promoting a service. To illustrate by way of example, the custom identifier might be chosen so as to include an component such as “//tag:”, “//service:”, “//V”, “/:tag:/”, “/:service:/”, and/or “/:V:/”.

So as to illustrate by way of example, it is noted that a custom identifier might, accordingly, be set to “//service:Yummy Beverage Corporation” or “//service:Yummy Beverage Corporation Presents Hot New Artist Videos”. It is noted that although these illustrative examples show the component indicating that the node and/or other computer is being employed in promoting a service at the beginning of the custom identifier, the component might, in various embodiments, be placed elsewhere within the custom identifier. For instance, the component might instead be placed at the end of the custom identifier or in the middle of the custom identifier.

The custom identifier for the node and/or other computer might, for instance, be settable by the user, company, and/or group via a provided Graphical User Interface (GUI) and/or other interface. Such an interface might, for instance, be provided by one or more software modules running remote from and/or at the node and/or other computer to be employed in promoting the service.

As another example, the user, company, and/or group wishing to employ the node and/or other computer in promoting the service might, in various embodiments, provide information to a remote store and/or server (step 103). Such a remote store and/or server receiving such information might, for example, store it. It is noted that, in various embodiments, a Local Interaction Server (LI Server) might be employed.

Such information might, for example, include the custom identifier chosen for the node and/or other computer and/or an assigned identifier corresponding to the node and/or other computer. Such an assigned identifier might, for instance, be a unique identifier such as a Media Access Control (MAC) address and/or Bluetooth address. It is noted that, in various embodiments, such an assigned identifier might be a network address.

Such provision might be implemented in a number of ways. For example, the information might be entered via one or more webpages, via one or more web applications, via one or more GUIs and/or other interfaces, and/or via one or more software modules. Such one or more webpages and/or web applications might, for instance, be remote from and/or at the store and/or server. Such software modules might, for instance, run remote from and/or at the node and/or other computer to be employed in promoting the service, and/or remote from and/or at a node and/or other computer usable by the user, company, and/or group wishing to promote a service. It is noted that, in various embodiments, such provision might involve use of cellular networking, wired networking, proximity connection, Internet connection, Simple Object Access Protocol (SOAP), Java Messaging Service (JMS), Remote Method Invocation (RMI), Short Message Service (SMS), Multimedia Messaging Service (MMS), and/or email.

The information provided to the remote store and/or server might, as another example, include information employable in accessing the service to be promoted by the node and/or other computer. Such information employable in accessing the service might, for instance, include a Uniform Resource Locator (URL), a network address, credentials employable in accessing the service (e.g., logins and/or passwords), and/or metadata. Such metadata might, for instance describe the service (e.g., provide descriptive text and/or keywords), specify type of service (e.g., video or webpage), and/or provide information employable in determining one or more software modules to be used in accessing the service.

It is noted that, in various embodiments, information provided to the remote store and/or server might be removed therefrom (e.g., by a system administrator). Such might be done, for instance, in the case of a service providing unacceptable and/or illegal content, and/or in the case where a provided custom identifier was unacceptable and/or illegal (e.g., was improperly making use of a trademarked name). Such removal might, for instance, be employed to prevent service promotion and/or access.

According to various embodiments, the user, company, and/or group might act to set the node and/or other computer to be employed in promoting the service to be discoverable (e.g., discoverable via device discovery and/or service discovery operations) (step 105). Such discoverability might, for instance, be set via GUI and/or other interface provided by one or more software modules running remote from and/or at the node and/or other computer to be employed in promoting the service, and/or another computer.

The user, company, and/or group might, in various embodiments, act to facilitate discovery of the node and/or other computer (e.g., via proximity connection) (step 107). For instance, the user, company, and/or group might place the node and/or other computer in a location, and/or have the node and/or other computer moved from location to location and/or within a location. Such locations might, for instance, be public locations. Such movement might, for instance, be achieved by having one or more individuals (e.g., hired individuals) carry the node and/or other computer.

It is noted that, according to various embodiments, services promoted by a node and/or other computer might, for example, include webpages, web services, Wireless Application Protocol (WAP) services, web applications, audio, video, communications (e.g., email, SMS, MMS, textual chat, telephone call, audio chat, and/or video chat), gaming, and/or software.

It is further noted that, in various embodiments, a user, company, and/or group might employ other than a node and/or other computer in promoting a service. For instance, a data tag (e.g., a Radio Frequency Identification (RFID) tag, an iButton, a barcode, an e-code, and/or the like) might be employed. Perhaps in a manner analogous to that discussed above, the user, company, and/or group might, for instance, provide information to a remote store and/or server of the sort discussed above.

Such information might, for example, include one or more values held by the data tag (e.g., a Globally Unique Identifier (GUID)). As another example, such information might include information, such as of the sort discussed above, employable in accessing the service to be promoted by the data tag. It is noted that, in various embodiments, stored on the data tag might be data indicting that the data tag is being employed in promoting a service.

Service Seeking Operations

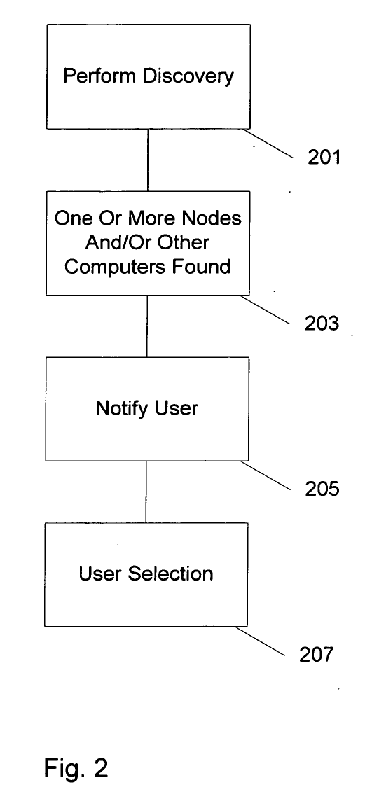

A user seeking services might, in various embodiments, employ a node and/or other computer in the endeavor. With respect to FIG. 2 it is noted that one or more software modules running remote from and/or at the node and/or other computer might, perhaps in response to a request by the user, act to perform device discovery and/or service discovery (step 201). Such a request might, for example, be submitted by the user via a GUI and/or other interface. As alluded to above, such device discovery and/or service discovery might, in various embodiments, involve the use of proximity connection.

In performing device discovery and/or service discovery, one or more software modules running remote from and/or at the node and/or other computer might, for example find one or more other nodes and/or other computers (step 203). Via the device discovery and/or service discovery one or more software modules running remote from and/or at the node and/or other computer being employed in seeking services might, for instance, receive custom identifiers and/or assigned identifiers of such other nodes and/or other computers.

Having received such custom identifiers and/or assigned identifiers, one or more software modules running remote from and/or at the node and/or other computer being employed in seeking services might, for instance, act to provide notification to the node and/or other computer's user regarding one or more of the nodes and/or other computers found via the device discovery and/or service discovery (step 205). It is noted that, in various embodiments, one or more software modules running remote from and/or at the node and/or other computer being employed in seeking services might act to provide notification to the node and/or other computer's user regarding only found nodes and/or other computers for which custom identifiers and/or assigned identifiers meeting certain criteria were received. Such criteria might, for instance, specify that the user receive notification regarding only found nodes and/or other computers determined to be promoting services (e.g., found nodes and/or other computers having custom identifier components indicating service promotion). Such criteria might, for example, be set by the user seeking services, a service provider, a manufacturer, and/or a system administrator).

One or more software modules running remote from and/or at the node and/or other computer being employed in seeking services might, for example, allow the node and/or other computer's user, perhaps via a GUI and/or other interface, to select one or more of the nodes and/or other computers found via the device discovery and/or service discovery to indicate desire for corresponding service access (step 207).

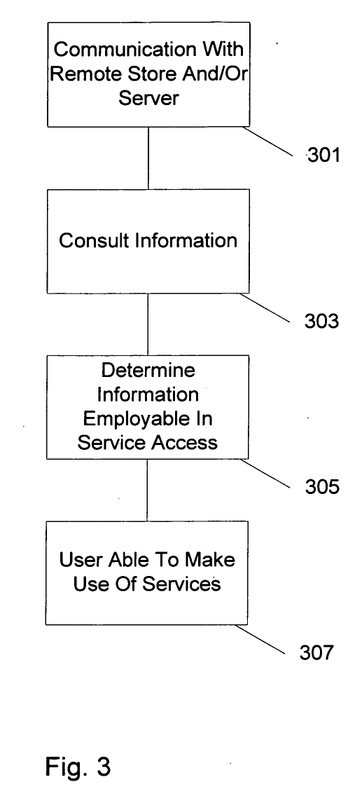

With respect to FIG. 3 it is noted that, responsive to such selection, one or more software modules running remote from and/or at the node and/or other computer being employed in seeking services might, for instance, communicate with the remote store and/or server (step 301). Via such communication one or more software modules running remote from and/or at the node and/or other computer being employed in seeking services might, in various embodiments, provide to the remote store and/or server received custom identifiers and/or assigned identifiers corresponding to the nodes and/or other computers selected by the user. In various embodiments, a service request, perhaps including received custom identifiers and/or assigned identifiers, might be dispatched to the remote store and/or server.

Such provision might be implemented in a number of ways. For example, one or more software modules running remote from and/or at the node and/or other computer might submit an http-get (Hypertext Transfer Protocol-get) request conveying the custom identifiers and/or assigned identifiers. Such conveying of the custom identifiers and/or assigned identifiers might, for instance, involve submission of an http-get request specifying a URL conveying the custom identifiers and/or assigned identifiers (e.g., via the path portion of the URL). To illustrate by way of example, in the case where one or more software modules running remote from and/or at the node and/or other computer being employed in seeking services were to submit such an http-get request to a server www.exemplaryserver.com conveying Bluetooth address 011c0ffee011, the http-get request might specify the URL:
http://www.exemplaryserver.com/011c0ffee011

The server to which such an http-get request is sent might, for example, be set by the user seeking services, a service provider, a manufacturer, and/or a system administrator. As another example, such an http-get request might be set in view of a received custom identifier (e.g., in view of a particular portion of a received custom identifier). For instance, such a request might be set in view of the portion of a received custom identifier other than a portion indicating that the custom identifier was of a node and/or other computer being employed in promoting a service.

To illustrate by way of example, in the case where the received custom identifier was “//service:Yummy Beverage Corporation”, the http-get request might be set in view of the “Yummy Beverage Corporation” portion of the custom identifier. Setting of the http-get request might, in various embodiments, involve removal of characters (e.g., spaces), appending of a prefix (e.g., “www.”), and/or appending of a top level domain (TLD) indicator (e.g., “.com’). To further illustrate by way of example, in the case where the received custom identifier was “//service:Yummy Beverage Corporation”, the http-get request might be directed to the server www.yummybeveragecorporation.com.

To additionally illustrate by way of example, in the case where the received custom identifier was “//service:Yummy Beverage Corporation”, and Bluetooth address 011c0ffee011 was to be conveyed, the http-get request might specify the URL:
http://www.yummybeveragecorporation.com/011c0ffee011

In various embodiments, one or more software modules running remote from and/or at the node and/or other computer being employed in seeking services might provide such custom identifiers and/or assigned identifiers to the remote store and/or server in a manner employing Simple Object Access Protocol (SOAP), Java Messaging Service (JMS), Remote Method Invocation (RMI), SMS, MMS, and/or email.

It is noted that, in various embodiments, communication between the node and/or other computer and the remote store and/or server might, for example, involve the use of proximity connection. As another example, other than proximity connection might be employed (e.g., wired networking and/or cellular networking might be employed). It is noted that, in various embodiments, Internet connection might be employed.

It is noted that, in various embodiments, one or more software modules running remote from and/or at the node and/or other computer being employed in seeking services might, for instance, employ in performing one or more operations custom identifiers and/or assigned identifiers corresponding to the nodes and/or other computers selected by the user, and/or information provided by one or more users, companies, and/or groups wishing to promote one or more services.

Such operations might, for example, include consulting information provided by one or more users, companies, and/or groups (step 303) so as to determine information employable in service access corresponding to the custom identifiers and/or assigned identifiers communicated by the node and/or other computer (step 305). It is noted that, in various embodiments, such one or more software modules performing such operations might, for example, run at the node or other computer being employed in seeking services, run at such a server, and/or run at a computer located with and in communication with such a store).

To illustrate by way of example, the one or more software modules might determine one or more URLs, network addresses, and/or credentials corresponding to the custom identifiers and/or assigned identifiers corresponding to the nodes and/or other computers selected by the user, and might act such that one or more software modules running remote from and/or at the node and/or other computer are able to provide the corresponding one or more services to its user. Accordingly, for instance, redirect might be employed, a URL and/or network address might be passed to one or more appropriate software modules employable in making a service available to a user (e.g., one or more software modules employed in browsing functionality, video presentation, and/or audio presentation), and/or one or more credentials may be applied. It is noted that, in various embodiments, one or more operations might be performed to determine if one or more custom identifiers and/or assigned identifiers provided to the remote store and/or server by the node or other computer being employed in seeking services matched information (e.g., identifiers) previously provided to and/or stored at the remote store and/or server. In various embodiments, in the case of a match, one or more operations might be performed to allow access to one or more services corresponding to custom identifiers and/or assigned identifiers provided to the remote store and/or server by the node or other computer being employed in seeking services (e.g., redirect might be employed).

It is noted that, in various embodiments, determination may be made (e.g., in view of metadata of the sort discussed above and/or one or more URLs) as to one or more software modules to be used in service access. For instance, the scheme of a URL might be taken into account in such determination. It is noted that, in various embodiments, the one or more software modules employable in making a service available to a user might run remote from and/or at the node and/or other computer being employed in seeking services.

Via, for example, the action of one or more software modules (e.g., the one or more software modules employable in making a service available to a user), the user seeking services could be able to make use of one or more of the services corresponding to the nodes and/or other computers that she selected (step 307). Accordingly, for example, one or more software modules running remote from and/or at the node and/or other computer being employed in seeking services might present webpages, videos, and/or audio to its user. Such presentation might, for instance, make use of audio and/or video capabilities of the node and/or other computer. In various embodiments, cellular networking, wired networking, proximity connection, and/or Internet connection might be employed.

It is noted that, in various embodiments, one or more software modules running remote from and/or at the node and/or other computer might query the node and/or other computer's user (e.g., via a GUI and/or other interface) regarding services presentation. For example, one or more software modules running remote from and/or at the node and/or other computer might allow the node and/or other computer's user to accept services presentation, decline services presentation, defer services presentation, and/or indicate one or more times for services presentation. In various embodiments, one or more software modules running remote from and/or at the node and/or computer might present to the node and/or other computer's user information regarding presentable services (e.g., service descriptions).

It is further noted that, in various embodiments, a user seeking services might employ a node and/or other computer in reading data from data tags. The node and/or other computer might, for example, include an integrated data tag reader. As another example, a data tag reader peripheral might be employed. Such a peripheral might, for instance, communicate with the node and/or other computer via Bluetooth, Universal Serial Bus (USB), or Firewire.

Reading data from a data tag being employed in promoting a service, one or more software modules running remote from and/or at the node and/or other computer being employed in seeking services might, perhaps in a manner analogous to that discussed above, perform one or more operations.

Such operations might, for instance, include providing notification to the node and/or other computer's user regarding one or more read data tags being employed in promoting services, allowing for user selection of such data tags, remote store and/or server communication, determining information employable in service access, and/or making one or more services available to the node and/or other computer's user.

Such determining information employable in service access might, for instance, involve consulting information provided by one or more users, companies, and/or groups wishing to employ one or more data tags in promoting one or more services, so as to determine information employable in service access corresponding to data read from one or more data tags (e.g., GUIDs).

It is noted that, in various embodiments a data tag might be known (e.g., by one or more software modules running remote from and/or at the node and/or other computer being employed in seeking services) to be one being employed in promoting one or more services by way of data, perhaps of the sort discussed above, read from the tag indicating such.

It is additionally noted that in various embodiments, middleware software (e.g., dedicated middleware software) might be launched in the case where a found node and/or other computer is determined to be promoting one or more services, and/or in the case where a data tag is known to be one being employed in promoting one or more services. Such middleware software might, for example, perform one or more operations discussed herein. For instance, such middleware software might communicate with the remote store and/or server as discussed herein, In various embodiments such middleware might, perhaps as discussed herein, provide to the remote store and/or server a service request and/or received custom identifiers and/or assigned identifiers.

It is further noted that, in various embodiments, a user seeking services may act to install on her node and/or other computer one or more software modules performing one or more operations discussed herein.

Further Promotion Operations

According to various embodiments, a user, company, and/or group might be able to employ a node and/or other computer, and/or a data tag, (e.g., an owned node and/or other computer, and/or a data tag) to promote a service on behalf of another user, company, and/or group. In various embodiments, the user, company, and/or group employing the node and/or other computer, and/or a data tag, to promote a service may be compensated by the other user, company, and/or group.

Such compensation might take a number of forms. For example, compensation might take the form of funds, coupons, physical items, services access (e.g., free access to a video service), ring tones, wallpaper, and/or software (e.g., games).

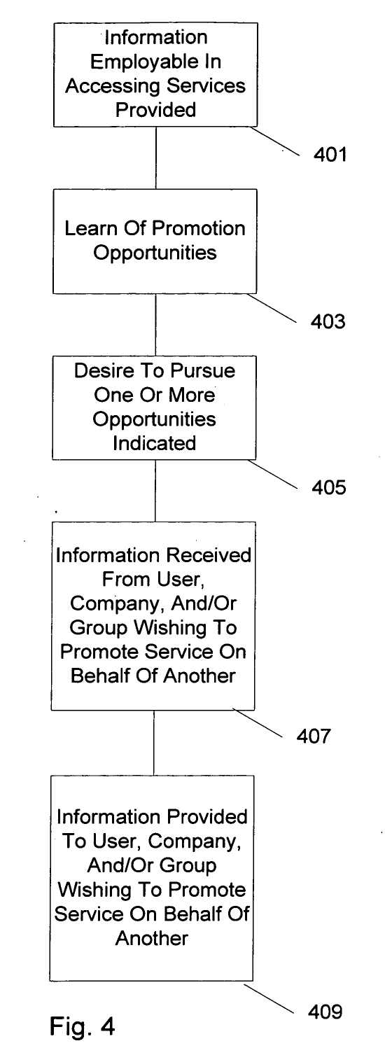

With respect to FIG. 4 it is noted that, a user, company, and/or group wishing other users, companies, and/or groups to promote one or more services might, for example, provide to a remote store and/or server (e.g., of the sort discussed above) information employable in accessing the services to be promoted (step 401). Such provision might, for instance, be performed in a manner analogous to that discussed above. Moreover, such information might, for instance, include information of the sort discussed above.

A user, company, and/or group wishing to employ a node and/or other computer, and/or a data tag, to promote a service on behalf of another user, company, and/or group might, for instance, employ a node and/or other computer to learn of opportunities for doing so. For example, request for learning of such opportunities might be indicated to one or more software modules running remote from and/or at the node and/or other computer via a provided GUI and/or other interface. Responsive to such request, one or more software modules running remote from and/or at the node and/or other computer might, for instance, communicate with a remote store and/or server (e.g., the remote store and/or server to which information was provided by the user, company, and/or group wishing for one or more services to be promoted). Such communication might, for example, be performed in a manner analogous to that discussed above.

Via such communication, one or more software modules running remote from and/or at the node and/or other computer might, for instance, come to learn of promotion opportunities (step 403). One or more software modules running remote from and/or at the node and/or other computer might, for example, act so that the user, company, and/or group wishing to promote services on behalf of another is informed (e.g., via a GUI and/or other interface) of such opportunities. As another example, one or more software modules running remote from and/or at the node and/or other computer might act so that the user, company, and/or group wishing to promote services on behalf of another can indicate (e.g., via a GUI and/or other interface) a desire to pursue one or more of the opportunities (step 405).

In various embodiments, in the case where a desire to pursue an opportunity for promotion is indicated, one or more operations might be performed. For example, one or more software modules running remote from and/or at the node and/or other computer might act to, perhaps via a GUI and/or other interface, provide information to and/or receive information from the user, company, and/or group wishing to promote services on behalf of another.

Such informing, allowing for indication, providing information, and/or receiving information might, for example, be performed in a manner analogous to that discussed above (e.g., one or more webpages, one or more web applications, one or more GUIs and/or other interfaces, and/or one or more software modules might be employed). Such webpages, web applications, GUIs and/or other interfaces, and/or software modules might, perhaps, be associated with and/or provided by the user, company, and/or group wishing for one or more services to be promoted. In various embodiments, tools employable in creating such webpages, web applications, GUIs and/or other interfaces, and/or software modules may be provided. For instance, tools for creating branded web interfaces for brand campaigns may be provided.

Information received from the user, company, and/or group wishing to promote a service on behalf of another might, for example, include one or more assigned identifiers (e.g., of the sort discussed above) corresponding to one or more nodes and/or other computers to be employed in services promotion, one or more values (e.g., of the sort discussed above) held by data tags to be employed in services promotion, and/or one or more custom identifiers chosen for one or more nodes and/or other computers to be employed in services promotion (step 407). As further examples, received information might include name, address, and/or billing information for the user, company, and/or group wishing to promote a service on behalf of another.

Information provided to the user, company, and/or group wishing to promote a service on behalf of another might, for example, include instructions for data tag placement, instructions for activating discoverability, instructions for activating appropriate communications (e.g., instructions for activating Bluetooth or WiFi), instructions for custom identifier setting (perhaps with identification of a custom identifier, perhaps of the sort discussed above, to be used), and/or instructions regarding one locations to visit and/or areas to roam with one or more nodes and/or other computers to be employed in services promotion (step 409).

It is noted that, in various embodiments, as an alterative to and/or in addition to requesting that operations (e.g., discoverability activation) be performed, one or more such operations could be performed automatically. For instance, one or more software modules running remote from and/or at a node and/or other computer to be employed in services promotion might perform one or more such operations. In various embodiments, such might be implemented in a manner employing remote communication, perhaps of the sort discussed above, between software modules. To illustrate by way of example, SOAP, RMI, and/or JMS might be employed.

In various embodiments, having received such information, having confirmed that requested operations (e.g., discoverability activation) had been performed, and/or having allowed for an amount of time (e.g., set by a user, a service provider, a manufacturer, and/or a system administrator) to have passed for such requested operations to be performed, one or more operations might be performed.

For example, the remote store and/or server to which information was provided by the user, company, and/or group wishing for one or more services to be promoted might come to hold and/or have access to information such that data tags, and/or nodes and/or other computers, being employed in services promotion are, perhaps in a manner analogous to that discussed above, associated with services. To illustrate by way of example, the Bluetooth address of a node and/or other computer might, for instance, be associated with information employable in accessing a corresponding service.

Data tags, and/or nodes and/or other computers, so being employed in promoting services might, for example, be employed, perhaps in a manner analogous to that discussed above, by users seeking services.

In various embodiments, statistics may be maintained regarding, for instance, the extent to which data tags, and/or nodes and/or other computers, promoting services are employed in services access by users seeking services.

Such statistics may be maintained in a number of ways. For example, one or more software modules running remote from and/or at one or more remote stores and/or servers associating custom identifiers and/or assigned identifiers of nodes and/or other computers, and/or values held by the data tags, with information employable in service access (e.g., one or more software modules running at such a server, and/or at a computer located with and in communication with such a store) might operate to maintain such statistics.

Such software modules, might, for instance, make note (e.g., in an accessible store) of instances of nodes and/or other computers seeking services providing custom identifiers, assigned identifiers, and/or values, and receiving information employable in service access. Such statistics might be accessible, for example, in a manner analogous to that discussed above (e.g., via SOAP, RMI, JMS, and/or website access).

Users, companies, and/or groups having other users, companies, and/or groups promote one or more services might, in various embodiments, have access to statistics relating to promotions being done on their behalf. Moreover, in various embodiments users, companies, and/or groups promoting one or more services on behalf of others might have access to statistics relating to promotions in which they are involved.

Statistics might, for instance, be employed by users, companies, and/or groups having other users, companies, and/or groups promote one or more services. For example, there may be interest in the success with which those other users, companies, and/or groups promote. In various embodiments, compensation provided to such other users, companies, and/or groups might be dependent on such success. Accordingly, for instance, in various embodiments users, companies, and/or groups having other users, companies, and/or groups promote one or more services might check such statistics, and provide compensation in view of achieved success.

Compensation may be provided in a number of ways. For example, in various embodiments, one or more software modules running remote from and/or at one or more remote stores and/or servers associating custom identifiers and/or assigned identifiers of nodes and/or other computers, and/or values held by the data tags, with information employable in service access (e.g., one or more software modules running at such a server, and/or at a computer located with and in communication with such a store) might operate to provide compensation. Such software modules might, for example, provide finds compensation by communicating with one or more banking and/or credit card software modules (e.g., one or more software modules running at bank and/or credit card company servers and/or other computers), provide physical items compensation by communicating with one or more warehouse and/or shipping software modules (e.g., one or more software modules running at warehouse and/or shipping management servers and/or other computers), provide services access compensation by communicating with one or more services access software modules (e.g., one or more software modules running at servers and/or other computers of service providers), and/or provide ring tones, wallpaper, and/or software compensation by communicating with one or more software modules capable of dispensing such (e.g., one or more software modules running at servers and/or other computers of providers of ring tones, wallpaper, and/or software). As another example, one or more software modules running remote from and/or at one or more remote stores and/or servers associating custom identifiers and/or assigned identifiers of nodes and/or other computers, and/or values held by the data tags, with information employable in service access might act to directly provide compensation.

It is further noted that, in various embodiments, users, companies, and/or groups having other users, companies, and/or groups promote one or more services might act to provide compensation.

It is noted that, in various embodiments, a user seeking services may act to install on her node and/or other computer one or more software modules performing one or more operations discussed herein.

Hardware and Software

Various operations and/or the like described herein may, in various embodiments, be executed by and/or with the help of computers. Further, for example, devices described herein may be and/or may incorporate computers. The phrases “computer”, “general purpose computer”, and the like, as used herein, refer but are not limited to a smart card, a media device, a personal computer, an engineering workstation, a PC, a Macintosh, a PDA, a portable computer, a computerized watch, a wired or wireless terminal, phone, communication device, node, and/or the like, a server, a network access point, a network multicast point, a network device, a set-top box, a personal video recorder (PVR), a game console, a portable game device, a portable audio device, a portable media device, a portable video device, a television, a digital camera, a digital camcorder, a Global Positioning System (GPS) receiver, a wireless personal sever, or the like, or any combination thereof, perhaps running an operating system such as OS X, Linux, Darwin, Windows CE, Windows XP, Windows Server 2003, Palm OS, Symbian OS, or the like, perhaps employing the Series 40 Platform, Series 60 Platform, Series 80 Platform, and/or Series 90 Platform, and perhaps having support for Java and/or .Net.

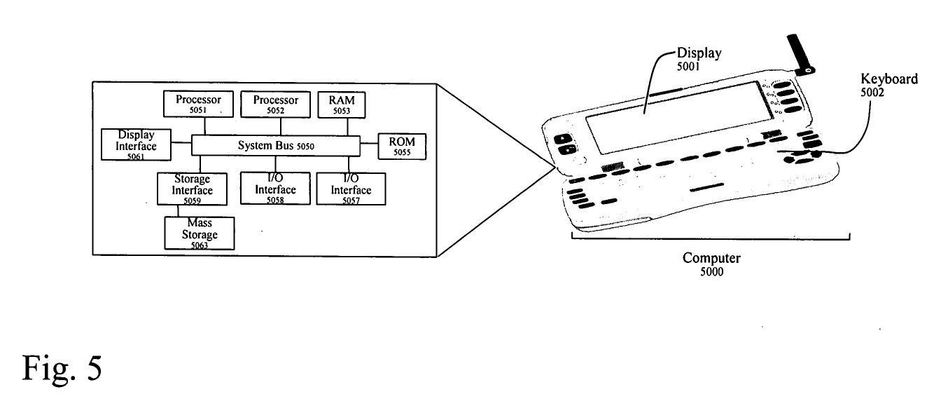

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Shown in FIG. 5 is an exemplary computer employable in various embodiments of the present invention. Exemplary computer 5000 includes system bus 5050 which operatively connects two processors 5051 and 5052, random access memory 5053, read-only memory 5055, input output (I/O) interfaces 5057 and 5058, storage interface 5059, and display interface 5061. Storage interface 5059 in turn connects to mass storage 5063. Each of I/O interfaces 5057 and 5058 may, for example, be an Ethernet, IEEE 1394, IEEE 1394b, IEEE 802.1a, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16x, IEEE 802.20, IEEE 802.15.3, ZigBee, Bluetooth, Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Global System for Mobile Communications (GSM), DVB-H (Digital Video Broadcasting: Handhelds), IrDA (Infrared Data Association), and/or other interface.

Mass storage 5063 may be a hard drive, optical drive, a memory chip, or the like. Processors 5051 and 5052 may each be a commonly known processor such as an IBM or Freescale PowerPC, an AMD Athlon, an AMD Opteron, an Intel ARM, an Intel XScale, a Transmeta Crusoe, a Transmeta Efficeon, an Intel Xenon, an Intel Itanium, an Intel Pentium, or an IBM, Toshiba, or Sony Cell processor. Computer 5000 as shown in this example also includes a touch screen 5001 and a keyboard 5002. In various embodiments, a mouse, keypad, and/or interface might alternately or additionally be employed. Computer 5000 may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using languages such as Java, Objective C, C, C#, C++, Perl, Python, and/or Comega according to methods known in the art. Corresponding program code might be placed on media such as, for example, DVD, CD-ROM, memory card, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various embodiments, peer-to-peer and/or grid computing techniques may be employed. It is additionally noted that, in various embodiments, remote communication among software modules may occur. Such remote communication might, for example, involve Simple Object Access Protocol (SOAP), Java Messaging Service (JMS), and/or Remote Method Invocation (RMI).

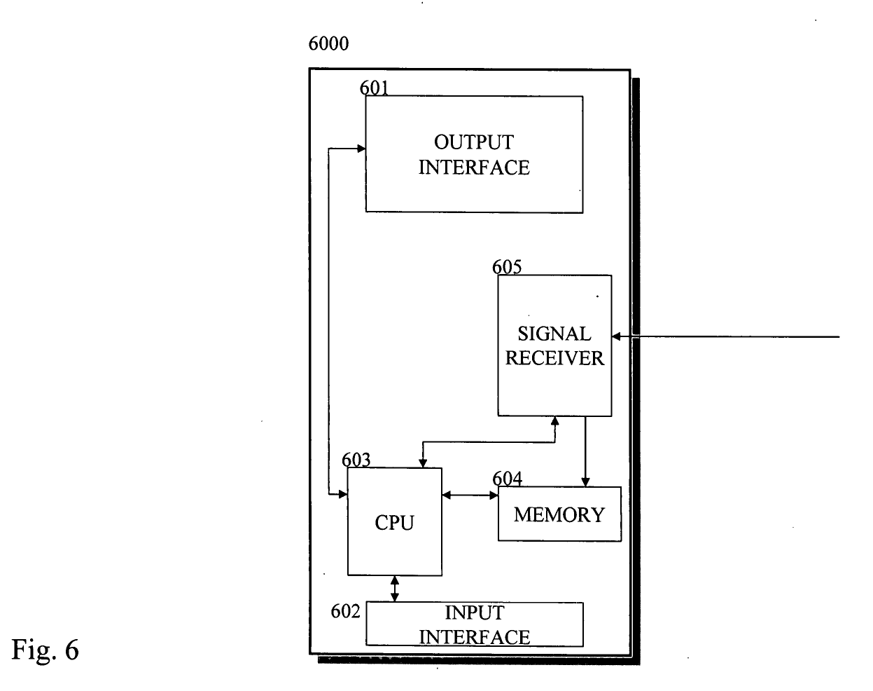

Shown in FIG. 6 is a block diagram of a terminal, an exemplary computer employable in various embodiments of the present invention. In the following, corresponding reference signs are applied to corresponding parts. Exemplary terminal 6000 of FIG. 6 comprises a processing unit CPU 603, a signal receiver 605, and a user interface (601, 602). Signal receiver 605 may, for example, be a single-carrier or multi-carrier receiver. Signal receiver 605 and the user interface (601, 602) are coupled with the processing unit CPU 603. One or more direct memory access (DMA) channels may exist between multi-carrier signal terminal part 605 and memory 604. The user interface (601, 602) comprises a display and a keyboard to enable a user to use the terminal 6000. In addition, the user interface (601, 602) comprises a microphone and a speaker for receiving and producing audio signals. The user interface (601, 602) may also comprise voice recognition (not shown).

The processing unit CPU 603 comprises a microprocessor (not shown), memory 604 and possibly software. The software can be stored in the memory 604. The microprocessor controls, on the basis of the software, the operation of the terminal 6000, such as receiving of a data stream, tolerance of the impulse burst noise in data reception, displaying output in the user interface and the reading of inputs received from the user interface. The hardware contains circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 6, alternatively, middleware or software implementation can be applied. The terminal 6000 can, for instance, be a hand-held device which a user can comfortably carry. The terminal 6000 can, for example, be a cellular mobile phone which comprises the multi-carrier signal terminal part 605 for receiving multicast transmission streams. Therefore, the terminal 6000 may possibly interact with the service providers.

It is noted that various operations and/or the like described herein may, in various embodiments, be implemented in hardware (e.g., via one or more integrated circuits). For instance, in various embodiments various operations and/or the like described herein may be performed by specialized hardware, and/or otherwise not by one or more general purpose processors. One or more chips and/or chipsets might, in various embodiments, be employed. In various embodiments, one or more Application-Specific Integrated Circuits (ASICs) may be employed.

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

What is claimed is:

1. A method, comprising:
receiving via proximity connection discovery from one or more devices one or more custom identifiers corresponding to the devices;
communicating with a remote destination;
learning of one or more services corresponding to one or more identifiers received via the proximity connection discovery; and
accessing one or more of the services.

2. The method of claim 1, further comprising providing information relating to one or more of the received custom identifiers.

3. The method of claim 1, further comprising receiving a selection corresponding to one or more of the custom identifiers.

4. The method of claim 1, wherein the one or more services are one or more of web services, wireless application protocol services, video services, audio services, telephone call services, short message service services, and multimedia messaging service services.

5. The method of claim 1, wherein one or more of the services are accessed via cellular network.

6. The method of claim 1, further comprising launching middleware software in response to determining one or more identifiers received via the proximity connection discovery to have components indicating service promotion.

7. The method of claim 6, wherein the middleware software creates a service request including one or more identifiers received via the proximity connection discovery, wherein the service request is dispatched to the remote destination.

8. A method, comprising:
receiving one or more identifiers corresponding to one or more devices employed in promoting services;
receiving data employable in accessing one or more services promoted by the one or more devices employed in promoting services;
storing one or more of the identifiers corresponding to the one or more devices employed in promoting services;
storing some or all of the received data;
receiving one or more identifiers from a seeking device;
determining one or more of the identifiers received from the seeking device to match one or more of the stored identifiers; and
providing the seeking device access to one or more services corresponding to one or more of the matching identifiers.

9. The method of claim 8, wherein redirect is employed in providing the seeking device access to the one or more services corresponding to the one or more of the matching identifiers.

10. The method of claim 8, wherein one or more of the identifiers received from the seeking device are custom identifiers received by the seeking device via proximity connection discovery.

11. The method of claim 8, wherein the one or more services corresponding to one or more of the matching identifiers are one or more of web services, wireless application protocol services, video services, audio services, telephone call services, short message service services, and multimedia messaging service services.

12. The method of claim 8, wherein the identifiers received from the seeking device are received via cellular network.

13. The method of claim 8, further comprising providing compensation for service promotion.

14. A method, comprising:
reading from one or more data tags data corresponding to the data tags;
communicating with a remote destination;
learning of one or more services, corresponding to some or all of the data read from the data tags; and
accessing one or more of the services.

15. The method of claim 14, further comprising launching middleware software in response to determining some or all of the data read from the data tags to have components indicating service promotion.

16. The method of claim 15, wherein the middleware software creates a service request including some or all of the data read from the data tags, wherein the service request is dispatched to the remote destination.

17. A system, comprising:
a memory having program code stored therein; and
a processor disposed in communication with the memory for carrying out instructions in accordance with the stored program code;
wherein the program code, when executed by the processor, causes the processor to perform:
receiving via proximity connection discovery from one or more devices one or more custom identifiers corresponding to the devices;
communicating with a remote destination;
learning of one or more services corresponding to one or more identifiers received via the proximity connection discovery; and
accessing one or more of the services.

18. The system of claim 17, wherein the processor further performs providing information relating to one or more of the received custom identifiers.

19. The system of claim 17, wherein the processor further performs receiving a selection corresponding to one or more of the custom identifiers.

20. The system of claim 17, wherein the one or more services are one or more of web services, wireless application protocol services, video services, audio services, telephone call services, short message service services, and multimedia messaging service services.

21. The system of claim 17, wherein one or more of the services are accessed via cellular network.

22. The system of claim 17, wherein the processor further performs launching middleware software in response to determining one or more identifiers received via the proximity connection discovery to have components indicating service promotion.

23. The system of claim 22, wherein the middleware software creates a service request including one or more identifiers received via the proximity connection discovery, wherein the service request is dispatched to the remote destination.

24. A system, comprising:
a memory having program code stored therein; and
a processor disposed in communication with the memory for carrying out instructions in accordance with the stored program code;
wherein the program code, when executed by the processor, causes the processor to perform:
receiving one or more identifiers corresponding to one or more devices employed in promoting services;
receiving data employable in accessing one or more services promoted by the one or more devices employed in promoting services;
storing one or more of the identifiers corresponding to the one or more devices employed in promoting services;
storing some or all of the received data;
receiving one or more identifiers from a seeking device;
determining one or more of the identifiers received from the seeking device to match one or more of the stored identifiers; and
providing the seeking device access to one or more services corresponding to one or more of the matching identifiers.

25. The system of claim 24, wherein redirect is employed in providing the seeking device access to the one or more services corresponding to the one or more of the matching identifiers.

26. The system of claim 24, wherein one or more of the identifiers received from the seeking device are custom identifiers received by the seeking device via proximity connection discovery.

27. The system of claim 24, wherein the one or more services corresponding to one or more of the matching identifiers are one or more of web services, wireless application protocol services, video services, audio services, telephone call services, short message service services, and multimedia messaging service services.

28. The system of claim 24, wherein the identifiers received from the seeking device are received via cellular network.

29. The system of claim 24, wherein the processor further performs providing compensation for service promotion.

30. A system, comprising:
a memory having program code stored therein; and
a processor disposed in communication with the memory for carrying out instructions in accordance with the stored program code;
wherein the program code, when executed by the processor, causes the processor to perform:
reading from one or more data tags data corresponding to the data tags;
communicating with a remote destination;
learning of one or more services corresponding to some or all of the data read from the data tags; and
accessing one or more of the services.

31. The system of claim 30, wherein the processor further performs launching middleware software in response to determining some or all of the data read from the data tags to have components indicating service promotion.

32. The system of claim 3 1, wherein the middleware software creates a service request including some or all of the data read from the data tags, wherein the service request is dispatched to the remote destination.

33. A node, comprising:
a memory having program code stored therein;
a processor disposed in communication with the memory for carrying out instructions in accordance with the stored program code; and
a network interface disposed in communication with the processor;
wherein the program code, when executed by the processor, causes the processor to perform:
receiving via proximity connection discovery from one or more devices one or more custom identifiers corresponding to the devices;
communicating with a remote destination;
learning of one or more services corresponding to one or more identifiers received via the proximity connection discovery; and
accessing one or more of the services.

34. The node of claim 33, further comprising a proximity connection interface, wherein the proximity connection interface is employed in performing the proximity connection discovery.

35. A server, comprising:
a memory having program code stored therein;
a processor disposed in communication with the memory for carrying out instructions in accordance with the stored program code; and
a network interface disposed in communication with the processor;
wherein the program code, when executed by the processor, causes the processor to perform:
receiving one or more identifiers corresponding to one or more devices employed in promoting services;
receiving data employable in accessing one or more services promoted by the one or more devices employed in promoting services;
storing one or more of the identifiers corresponding to the one or more devices employed in promoting services;
storing some or all of the received data;
receiving one or more identifiers from a seeking device;
determining one or more of the identifiers received from the seeking device to match one or more of the stored identifiers; and
providing the seeking device access to one or more services corresponding to one or more of the matching identifiers.

36. An article of manufacture comprising a computer readable medium containing program code that when executed causes a node to perform:
receiving via proximity connection discovery from one or more devices one or more custom identifiers corresponding to the devices;
communicating with a remote destination;
learning of one or more services corresponding to one or more identifiers received via the proximity connection discovery; and
accessing one or more of the services.

37. An article of manufacture comprising a computer readable medium containing program code that when executed causes a server to perform:
receiving one or more identifiers corresponding to one or more devices employed in promoting services;
receiving data employable in accessing one or more services promoted by the one or more devices employed in promoting services;
storing one or more of the identifiers corresponding to the one or more devices employed in promoting services;
storing some or all of the received data;
receiving one or more identifiers from a seeking device;
determining one or more of the identifiers received from the seeking device to match one or more of the stored identifiers; and
providing the seeking device access to one or more services corresponding to one or more of the matching identifiers.
